(19) United States
(12) Patent Application Publication
(10) Pub. No.: US 2007/0229714 A1
(43) Pub. Date: Oct. 4, 2007

(54) Broadcasting system and broadcasting transmitter and broadcasting receiver constituting the system

(75) Inventor: Yoshihisa Nagamura, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/727,749

(22) Filed: Mar. 28, 2007

(30) Foreign Application Priority Data
Mar. 28, 2006 (JP) 2006-087064

(51) Int. Cl. H04N 5/46

(52) U.S. Cl. 348/729

(57) ABSTRACT

In a broadcasting system including a broadcasting transmitter (10) for transmitting image and audio data and a broadcasting receiver (20) equipped with a recording medium (11), the broadcasting transmitter adds reuse information to a data to be reused and transmits the data, and the broadcasting transmitter transmits reuse instruct information when it instructs to reuse, and the broadcasting receiver records the data with the reuse information on the recording medium, and the broadcasting receiver reads out the data with the designated reuse information from the recording medium and reproduces the data when the reuse instruct information is issued.

This application is based on Japanese Patent Application No. 2006-087064 filed on Mar. 28, 2006, the contents of which are hereby incorporated by reference.

### BACKGROUND OF THE INVENTION

1. Field of the Invention

The present invention relates to a broadcasting system for TV (Television) broadcasting or the like, which includes a broadcasting transmitter and a broadcasting receiver.

2. Description of Related Art

Conventionally, there are broadcasting systems for broadcasting programs and commercials that are proposed as follows.

For example, JP-A-2005-341104 discloses an advertising information providing system that includes a user terminal and an advertisement management system for providing advertisement and advertising information whose broadcast period is expired, that are connected to each other via a network, in which the user terminal performs a step for making connection with the advertisement management system via communication means, a step for transmitting a search condition, a step for receiving corresponding advertisement and advertising information if a search result presents, and a step for reproducing the received advertisement and advertising information by reproducing means. Thus, in the system disclosed in JP-A-2005-341104, advertisements are stored in the advertisement management system.

In addition, JP-A-2004-135273 discloses a system in which a TV set is equipped with storage means for forcing storage, so that advertising information is received and stored selectively.

In addition, JP-A-2003-209822 discloses a pay TV program service method in which accumulated data broadcasting is utilized. The broadcasting station broadcasts a plurality of advertisement programs having a predetermined discount and a plurality of pay programs and makes a storage device of a user's receiver store them. After that, when the user selects a pay program for watching or reproducing it, the user may select advertising information that is received together with the pay program. When the user watches the advertisement program and the pay program successively, the discount corresponding to the watched advertisement program is subtracted from the price of the pay program for charging.

The technique disclosed in the above-mentioned JP-A-2005-341104, JP-A-2004-135273, or JP-A-2003-209822 focuses attention on how effectively an advertisement data is used in a broad sense.

Recently, a shift from analog broadcasting to digital broadcasting is being carried on. The digital broadcasting requires large quantity of data and a wide frequency band for improving image quality and for adding data broadcasting. Therefore, it becomes an important task how to reduce quantity of data transmitted from the broadcasting station while adding various services such as data broadcasting. If quantity of transmission data can be reduced, more services can be provided by the same frequency band.

### SUMMARY OF THE INVENTION

In view of the above described problem, it is an object of the present invention to provide a broadcasting system in which a broadcasting receiver can utilize data transmitted from a broadcasting transmitter of a broadcasting station effectively so that improved services can be provided by the same frequency band. Further, it is another object of the present invention to provide a broadcasting transmitter and a broadcasting receiver that constitute the broadcasting system.

To attain the above described first object, a broadcasting system in accordance one aspect of the present invention includes a broadcasting transmitter for transmitting image and audio data and a broadcasting receiver equipped with a recording medium. And the broadcasting system is characterized by a structure in that the broadcasting transmitter adds reuse information to a data to be reused and transmits the data, and the broadcasting transmitter transmits reuse instruct information when it instructs to reuse, and the broadcasting receiver records the data with the reuse information on the recording medium, and the broadcasting receiver reads out the data with the designated reuse information from the recording medium and reproduces the data when the reuse instruct information is issued.

According to this first structure, quantity of transmission data can be reduced in a case of rebroadcasting or the like because the broadcasting transmitter does not transmit image and audio data.

In the above described broadcasting system with the first structure, the reuse information may be a unique identification code that means reuse.

In the above described broadcasting system with the first structure, the image and audio data may be TV broadcasting data, and the recording medium may be a hard disk.

To attain the above described second object, a broadcasting transmitter for transmitting image and audio data in accordance another aspect of the present invention is characterized by a structure in that the broadcasting transmitter adds reuse information to a data to be reused and transmits the data, and the broadcasting transmitter transmits reuse instruct information when it instructs to reuse.

To attain the above described second object, a broadcasting receiver equipped with a recording medium in accordance other aspect of the present invention is characterized by a structure in that if the reuse information is included in the received data, the data is recorded on the recording medium, and the broadcasting receiver reads out the data with the designated reuse information from the recording medium and reproduces the data when the reuse instruct information is issued.

According to the present invention, quantity of transmission data can be reduced so that free range can be created in a frequency band in a case of rebroadcasting or the like because the broadcasting transmitter does not transmits image and audio data. The created free range in a frequency band can be used for adding data broadcasting or other various services. Therefore, more services can be provided by the same frequency band. In addition, it is also possible not to add a new service so that data can be transmitted and received more stably due to the created free range in a frequency band.

### BRIEF DESCRIPTION OF THE DRAWINGS

FIG. 1 is a block diagram to show a structure of a main part of a broadcasting transmitter.

FIG. 2 is a block diagram to show a structure of a main part of a broadcasting receiver and its peripheral equipment.

### DETAILED DESCRIPTION OF THE PREFERRED EMBODIMENTS

A broadcasting system in accordance with one aspect of the present invention is a system that includes a broadcasting transmitter for transmitting image and audio data, and a broadcasting receiver equipped with a recording medium. It can be used for a TV broadcasting system, for example.

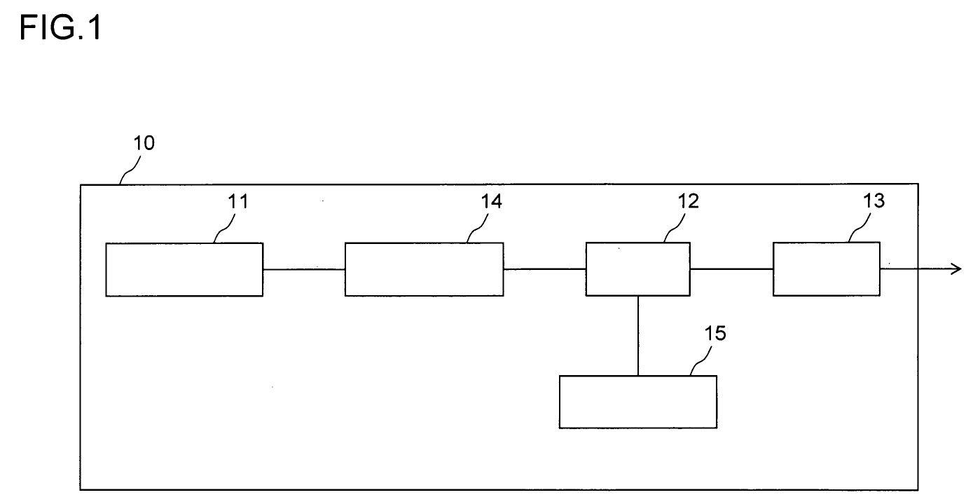

FIG. 1 is a block diagram to show a structure of a main part of a broadcasting transmitter. The broadcasting transmitter 10 that is installed in a broadcasting station includes a recording medium reproducing portion 11 that reproduces a recording medium such as a DVD (Digital Versatile Disc), a video tape or the like on which a broadcasting program is recorded, a multiplexer (MUX) 12 that multiplexes data so that the data can be transmitted, a modulator 13 that modulates the data supplied from the MUX 12 by a modulation technique such as Quadrature Amplitude Modulation (QAM) or the like, a reuse deciding portion 14 that is disposed between the recording medium 11 and the MUX 12 so as to decide whether or not the data supplied from the recording medium reproducing portion 11 is a data to be reused, and a reuse information generating portion 15 that generates reuse information when the reuse deciding portion 14 decides that the data supplied from the recording medium reproducing portion 11 is a data to be reused.

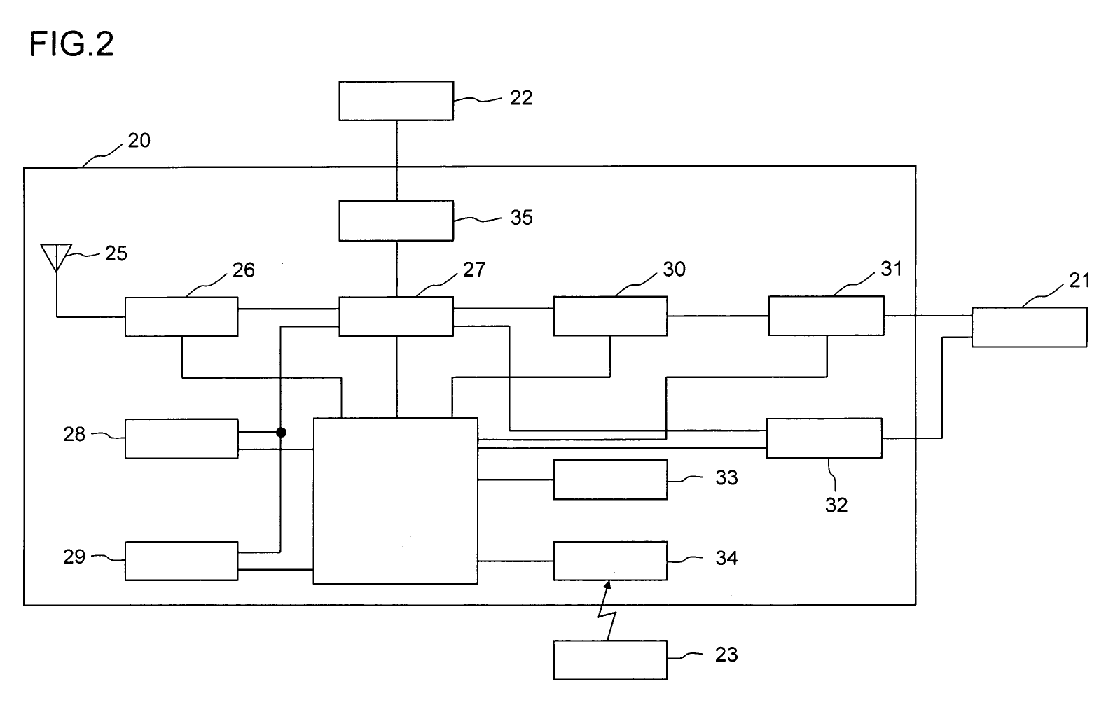

FIG. 2 is a block diagram to show a structure of a main part of a broadcasting receiver and its peripheral equipment. As a broadcasting receiver 20 that is installed at home, an optical disc apparatus with an integrated hard disk drive (HDD) is exemplified in FIG. 2 for explanation. The broadcasting receiver 20 is connected to a display device 21 such as a TV set and an external device 22 represented by a picture and audio recording apparatus such as a set top box of CATV, satellite broadcasting, or the like, a video deck or the like. In addition, the broadcasting receiver 20 can be operated by using a remote controller 23. In the following description, a DVD will be exemplified as the optical disc for explanation.

The broadcasting receiver 20 is equipped with an antenna 25 that receives TV broadcasting signals, a tuner 26 that demodulates and digitizes the TV broadcasting signal received by the antenna 25, an image and audio compression and expansion portion 27 that compresses and encodes an image and audio data received from the tuner 26 or the external device 22 in accordance with MPEG2 or the like as well as expands and decodes the compressed image data that is reproduced by a HDD recording and reproducing portion 28 or a DVD recording and reproducing portion 29, the HDD recording and reproducing portion 28 that records in the HDD the compressed image and audio data that is received from the image and audio compression and expansion portion 27 and reproduces data recorded in the HDD, the DVD recording and reproducing portion 29 that records on a loaded DVD the compressed image and audio data that is received from the image and audio compression and expansion portion 27 and reproduces data recorded on a DVD, an On-Screen Display (OSD) portion 30 that displays various setting values on a part of the display device 21 so that the setting values can be set, an image output portion 31 that converts an image signal from the OSD portion 30 into an analog signal and supplies it to the display device 21, an audio output portion 32 that converts an audio signal from the image and audio compression and expansion portion 27 into an analog signal and supplies it to the display device, a memory 33 that is made up of a ROM and a RAM, a remote controller receiving portion 34 that receives a signal from the remote controller 23, an external I/F (interface) 35 that is connected to the external device 22, and a control portion 36 that controls the individual portions of the broadcasting receiver 20.

In the broadcasting system that includes the broadcasting transmitter 10 and the broadcasting receiver 20, the broadcasting transmitter 10 adds reuse information to the data to be reused and transmits the data, and it transmits reuse instruct information when it instructs to reuse. On the other hand, the broadcasting receiver 20 records the data with the reuse information in the HDD. Then, if the reuse instruct information is issued, the broadcasting receiver 20 reads out the data having the designated reuse information from the HDD and reproduce it.

More specifically, the recording medium reproducing portion 11 of the broadcasting transmitter 10 reproduces a program for broadcasting. It is decided by the reuse deciding portion 14 whether or not the data is a data to be reused. If it is scheduled that the same data is transmitted after that time, the data is decided to be a data to be reused. In other words, if there is a plan of rebroadcasting, running the same commercial, or running the same opening or ending in a program, it is preferable to reuse the data.

The data that is decided to be reused is assigned with reuse information by the MUX 12. The reuse information is generated in the reuse information generating portion 15. The reuse information is, for example, a unique identification code that means reuse. As a concrete example, a packet ID (PID) may be a special number, or a unique identification code may be included in a real data.

Then, the data that is sent from the MUX 12 to the modulator 13 is transmitted to the broadcasting receiver 20 as a TV broadcasting signal. The broadcasting receiver 20 detects the reuse information from the received TV broadcasting signal, and the data assigned with the reuse information is supplied to the display device 21 and at the same time it is stored in the HDD. The data to be reused that is stored in the HDD cannot be erased by the user. If the reuse information is written in the PID, it is recorded in the HDD together with the data. If a unique identification code is added to the real data, a management table that is a list of the identification code and a record position of the data is generated and is stored in the memory 33 or the like. By this arrangement, the data can be read out from the PID or the identification code at any time.

If the broadcasting transmitter 10 broadcasts again the data that was delivered with the reuse information before for a reason of rebroadcasting or the like, the reuse information generating portion 15 generates the same information as the reuse information that was generated before, and it is added to the data in the MUX 12. At this point, the data to which the reuse information is added does not include images and sounds but includes a data that instructs the reuse, i.e., the reuse instruct information.

Then, the data that is sent from the MUX 12 to the modulator 13 is transmitted to the broadcasting receiver 20 as a TV broadcasting signal. The broadcasting receiver 20 detects the reuse instruct information from the received TV broadcasting signal so as to recognize the instruction to reuse. Then, it reads out the data having the designated reuse information from the HDD and supplies the data to the display device 21.

According to this structure, the broadcasting transmitter 10 does not transmit the image and audio data in a case of rebroadcasting or the like, so quantity of transmission data can be reduced. Then, there is created a free space in a frequency band, so that data broadcasting or other various services can be added. Therefore, more services can be provided by the same frequency band. In addition, it is also possible not to add a new service so that data can be transmitted and received more stably due to the created free range in a frequency band.

It should be understood that it is preferable to transmit and receive a data to be reused like commercials so that it is stored in the HDD late at night in the present invention, so that the data can be reused in the daytime. Thus, more services can be provided.

The present invention can be utilized for a broadcasting system such as a TV broadcasting system. Although the broadcasting receiver is preferably a TV broadcasting receiver equipped with an HDD or a hard disk recorder, it may be a video cassette recorder or an optical disc apparatus such as a DVD recorder or the like. The present invention can also be utilized for a multiple function apparatus that is equipped with the functions thereof.

What is claimed is:

1. A broadcasting system comprising a broadcasting transmitter for transmitting image and audio data and a broadcasting receiver equipped with a recording medium, wherein
the broadcasting transmitter adds reuse information to a data to be reused and transmits the data, and the broadcasting transmitter transmits reuse instruct information when it instructs to reuse, and
the broadcasting receiver records the data with the reuse information on the recording medium, and the broadcasting receiver reads out the data with the designated reuse information from the recording medium and reproduces the data when the reuse instruct information is issued.

2. The broadcasting system according to claim 1, wherein the reuse information is a unique identification code that means reuse.

3. The broadcasting system according to claim 2, wherein the image and audio data are TV broadcasting data, and the recording medium is a hard disk.

4. A broadcasting transmitter for transmitting image and audio data, wherein
the broadcasting transmitter adds reuse information to a data to be reused and transmits the data, and the broadcasting transmitter transmits reuse instruct information when it instructs to reuse.

5. A broadcasting receiver equipped with a recording medium, wherein
if the reuse information is included in the received data, the data is recorded on the recording medium, and
the broadcasting receiver reads out the data with the designated reuse information from the recording medium and reproduces the data when the reuse instruct information is issued.
